(19) United States
(12) Patent Application Publication
(10) Pub. No.: US 2003/0041144 A1
(43) Pub. Date: Feb. 27, 2003

(54) Method of evaluating reliability of transmission line as route, system for implementing the method, program for evaluating reliability of transmission line as route, and recording medium in which the same program has been recorded

(76) Inventors: Hironori Kouzaki, Tokyo (JP); Kazuhiro Ootsuki, Tokyo (JP); Jiro Mori, Hokkaido (JP); Ken Nishiwaki, Tokyo (JP)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/225,960

(22) Filed: Aug. 22, 2002

(30) Foreign Application Priority Data
Aug. 22, 2001 (JP) P2001-252016

(51) Int. Cl. G06F 15/173

(52) U.S. Cl. 709/224; 709/225

(57) ABSTRACT

A state in which each of sections constituting a transmission line is installed is obtained as data from the database for facility evaluation, and the facility-evaluation value of each section is calculated according to the state in which each section is installed and the facility-evaluation rank of the transmission line as a route is determined by a means for determining the facility-evaluation rank. On the other hand, the environment state in which each section of the transmission line is present is obtained as data from the database for environment evaluation, and the environment-evaluation value of each section is calculated according to the environment state of each section and the environment-evaluation rank of the transmission line as a route is determined by a means for determining the environment-evaluation rank. Reliability of the transmission line as a route is then determined, by a means for evaluating reliability, based on the facility-evaluation rank, the environment-evaluation rank, and redundancy of the transmission line as a route.

### CROSS REFERENCE TO RELATED APPLICATION

This application claims benefit of priority under 35 U.S.C. §119 to Japanese Patent Application No.2001-252016, filed on Aug. 22, 2001, the entire contents of which are incorporated by reference herein.

### BACKGROUND OF THE INVENTION

1. Field of the Invention

The present invention relates to a method of evaluating reliability of a transmission line as a route (for information technology) constituted of a plurality of sections, a system for implementing the method, a program for evaluating reliability of a transmission line as a route, and a recording medium in which the program has been recorded.

2. Description of the Related Art

As a result of the rapid spread of new information technology for communication including internet and mobile phones (i.e., as a result of the IT revolution), reliability of facilities of a transmission line which supports the information communication is now becoming increasingly an important issue.

Privatization of the information communication industries, free use of network, and utilization of underground spaces are steadily in progress. In such an environment, each firm of the communication industries no longer persists to possessing a conduit for communication of its own but is aggressively establishing a new transmission line as a route by utilizing the facilities which already exist and are capable of accommodating communication cables (such as sewerage). As a result, each firm of the communication industries is now able to establish a transmission line as a route in a much cheaper and quicker manner, than establishing a conduit for communication by itself.

In general, a transmission line as a route is constituted of a plurality of cable-accommodating facilities belonging to different owners. Due to this, reliability of each facility varies depending on the owners, and some of the sections constituting the transmission line as a route may lack reliability of facilities. Further, some of the sections constituting the transmission line as a route may be vulnerable to accidents caused by human or natural disasters, which could affect information communication.

### SUMMARY OF THE INVENTION

The present invention has been achieved in order to solve the problems described above. One object of the present invention is to provide a method of evaluating reliability of a transmission line as a route (for information technology), a system for implementing the method, a program for evaluating reliability of a transmission line as a route, and a recording medium in which the program has been recorded, according to which reliability of facilities of each of the sections constituting the transmission line as a route is quantitatively evaluated, the influence of the evaluated reliability on the transmission line (route) as a network is specifically expressed as an index, so that the obtained result can be reflected on the check/maintenance of the facilities and the planning of establishing a network.

In order to achieve the aforementioned object, in a first aspect of the present invention, there is provided a method of evaluating reliability of a transmission line as a route constituted of a plurality of sections, comprising the steps of: evaluating facilities of each of the sections constituting the transmission line as a route, according to a state in which each section of the transmission line is installed, and determining a facility-evaluation rank of the transmission line as a route based on an evaluation result of facilities; evaluating environment of each of the sections constituting the transmission line, according to a state of environment in which each section is present, and determining an environment-evaluation rank of the transmission line as a route based on an evaluation result of environment; and evaluating reliability of the transmission line as a route, based on the facility-evaluation rank, the environment-evaluation rank, and redundancy of the transmission line as a route.

According to the first aspect of the present invention, facilities of each of the sections of the transmission line are evaluated according to a state in which each section of the transmission line is installed and the facility-evaluation rank of the transmission line as a route is determined based on the evaluation result of facilities; the environment of each of the sections is evaluated according to a state of environment in which each section is present and the environment-evaluation rank of the transmission line as a route is determined based on the evaluation result of environment; and reliability of the transmission line as a route is evaluated based on the facility-evaluation rank, the environment-evaluation rank, and redundancy of the transmission line as a route. Thus, reliability of the transmission line as a route is determined in an accurate and quantitative manner, so that the obtained data of reliability of the transmission line can be reflected on the facility-maintenance plan and the network-establishing plan in future. Further, as the critical points at the route are correctly grasped, checks for preventive maintenance and strategy-planning at the time of accidents can be conducted accurately and quickly, whereby reliability of the transmission line as a route is ensured.

In one preferable embodiment of the present invention, at the step of determining the facility-evaluation rank, the state in which each section of the transmission line is installed includes: whether the transmission line is buried underground or not; and whether the transmission line is aerially provided or not, the state also including a depth at which the transmission line in buried if the transmission line is buried underground.

According to this embodiment, the evaluation of facilities of each section is carried out in consideration of the state in which each section of the transmission line is installed, which state including whether the transmission line is buried underground or not; and whether the transmission line is aerially provided or not, the state also including a depth at which the transmission line is buried if the transmission line is buried underground. Thus, the evaluation of facilities of the transmission line as a route can be accurately carried out.

In another preferred embodiment of the present invention, at the step of determining the environment-evaluation rank, the environment state of each section of the transmission line includes at least one of: a location of a road under which road the transmission line lies; a state of soil; presence/absence of fire-proof protection; presence/absence of shallow underground section protection; and a state of urbanization.

According to this embodiment, the environment of each section of the transmission line is evaluated based on the environment state of each section, the environment state of each section including at least one of: a location of a road under which road the transmission line lies; a state of soil; presence/absence of fire-proof protection; presence/absence of shallow underground section protection; and a state of urbanization. Thus, evaluation of the environment of the transmission line as a route can be accurately carried out.

Further, in order to achieve the aforementioned object, as a second aspect of the present invention, there is provided a method of evaluating reliability of a transmission line as a route constituted of a plurality of sections, comprising the steps of: registering, for management as data for each section of the transmission line as a route, a state in which each of the sections of the transmission line is installed, in a database for facility evaluation; obtaining as data the state in which each section of the transmission line is installed, from the database for facility evaluation, evaluating facilities of each section according to the state in which each section is installed, and calculating the facility-evaluation value of each section, thereby determining the facility-evaluation rank of the transmission line as a route based on facility-evaluation values of respective sections; registering, for management as data for each section of the transmission line as a route, an environment state in which each of the sections of the transmission line is present, in a database for environment evaluation; obtaining as data the environment state of each section of the transmission line, from the database for environment evaluation, evaluating environment of each section according to the environment state of each section, and calculating the environment-evaluation value of each section, thereby determining the environment-evaluation rank of the transmission line as a route based on environment-evaluation values of the respective sections; and evaluating reliability of the transmission line as a route, based on the facility-evaluation rank, the environment-evaluation rank, and redundancy of the transmission line as a route.

According to the second aspect of the present invention, the state in which each section of the transmission line is installed is obtained as data from the database for facility evaluation, the facility-evaluation value of each section is calculated according to the state in which each section is installed, whereby the facility-evaluation rank of the transmission line as a route is determined; the environment state in which each section of the transmission line is present is obtained as data from the database for environment evaluation, the environment-evaluation value of each section is calculated according to the obtained environment state of each section, thereby determining the environment-evaluation rank; and reliability of the transmission line as a route is determined based on the facility-evaluation rank, the environment-evaluation rank, and redundancy of the transmission line as a route. Thus, reliability of the transmission line as a route is determined in an accurate and quantitative manner, so that the obtained data of reliability of the transmission line can be reflected on the facility-maintenance plan and the network-establishing plan in future. Further, as the critical points at the route are correctly grasped, checks for preventive maintenance and strategy-planning at the time of accidents can be conducted accurately and quickly, whereby reliability of the transmission line as a route is ensured.

In yet another preferred embodiment of the present invention, at the step of registering as data a state in which the transmission line is installed, for management, in a database for facility evaluation, the state in which the transmission line is installed includes: whether the transmission line is buried underground or not; and whether the transmission line is aerially provided or not, the state also including a depth at which the transmission line is buried if the transmission line is buried underground.

According to this embodiment, the evaluation of facilities of each section is carried out in consideration of the state in which each section of the transmission line is installed, which state including whether the transmission line is buried underground or not; and whether the transmission line is aerially provided or not, the state also including a depth at which the transmission line is buried if the transmission line is buried underground. Thus, the evaluation of facilities of the transmission line as a route can be accurately carried out.

In another preferred embodiment of the present invention, at the step of registering an environment state of the transmission line, for management, in a database for environment evaluation, the environment state of the transmission line includes at least one of: a location of a road under which road the transmission line lies; a state of soil; presence/absence of shallow underground section protection; and a state of urbanization.

According to this embodiment, the environment of each section of the transmission line is evaluated based on the environment state of each section, the environment state of each section including at least one of: a location of a road under which road the transmission line lies; a state of soil; presence/absence of fire-proof protection; presence/absence of shallow underground section protection; and a state of urbanization. Thus, evaluation of the environment of the transmission line as a route can be accurately carried out.

Further, in order to achieve the aforementioned object, in a third aspect of the present invention, there is provided a system for evaluating reliability of a transmission line as a route constituted of a plurality of sections, comprising: a means for evaluating facilities of each of the sections constituting the transmission line as a route, according to a state in which each section is installed, and determining a facility-evaluation rank of the transmission line as a route based on an evaluation result of facilities; a means for evaluating the environment of each of the sections constituting the transmission line, according to a state of environment in which each section is located, and determining an environment-evaluation rank of the transmission line as a route based on an evaluation result of environment; and a means for evaluating reliability of the transmission line as a route, based on the facility-evaluation rank, the environment-evaluation rank, and redundancy of the transmission line as a route.

According to the third aspect of the present invention, facilities of each of the sections of the transmission line are evaluated according to a state in which each section is installed and the facility-evaluation rank of the transmission line as a route is determined based on the evaluation result of facilities; the environment of each of the sections is evaluated according to an environment state in which each section is present and the environment-evaluation rank of the transmission line as a route is determined based on the evaluation result of environment; and reliability of the transmission line as a route is evaluated based on the facility-evaluation rank, the environment-evaluation rank, and redundancy of the transmission line as a route. Thus, reliability of the transmission line as a route is determined in an accurate and quantitative manner, so that the obtained data of reliability of the transmission line can be reflected on the facility-maintenance plan and the network-establishing plan in future. Further, as the critical points at the route are correctly grasped, checks for preventive maintenance and strategy-planning at the time of accidents can be conducted accurately and quickly, whereby reliability of the transmission line as a route is ensured.

In yet another preferable embodiment of the present invention, in the means for determining the facility-evaluation rank, the state in which each section of the transmission line is installed includes: whether the transmission line is buried underground or not; and whether the transmission line is aerially provided or not, the state also including a depth at which the transmission line is buried if the transmission line is buried underground.

According to this embodiment, the evaluation of facilities of each section is carried out in consideration of the state in which each section of the transmission line is installed, which state including whether the transmission line is buried underground or not; and whether the transmission line is aerially provided or not, the state also including a depth at which the transmission line is buried if the transmission line is buried underground. Thus, the evaluation of facilities of the transmission line as a route can be accurately carried out.

In yet another preferred embodiment of the present invention, in the means for determining the environment-evaluation rank, the environment state of each section of the transmission line includes at least one of: a location of a road under which road the transmission line lies; a state of soil; presence/absence of fire-proof protection; presence/absence of shallow underground section protection; and a state of urbanization.

According to this embodiment, the environment of each section of the transmission line is evaluated based on the environment state of each section, the environment state of each section including at least one of: a location of a road under which road the transmission line lies; a state of soil; presence/absence of fire-proof protection; presence/absence of shallow underground section protection; and a state of urbanization. Thus, evaluation of the environment of the transmission line as a route can be accurately carried out.

Further, in order to achieve the aforementioned object, as a fourth aspect of the present invention, there is provided a system for evaluating reliability of a transmission line as a route constituted of a plurality of sections, comprising: a database for facility evaluation, for registering therein, for management as data for each section of the transmission line as a route, a state in which each of the sections of the transmission line is installed; a means for obtaining as data the state in which each section of the transmission line is installed, from the database for facility evaluation, evaluating facilities of each section according to the state in which each section is installed, and calculating a facility-evaluation value of each section, thereby determining a facility-evaluation rank of the transmission line as a route based on facility-evaluation values of respective sections; a data for environment evaluation, for registering therein, for management as data for each section of the transmission line as a route, an environment state in which each of the sections of the transmission line is present; a means for obtaining as data the environment state of each section of the transmission line, from the database for environment evaluation, evaluating environment of each section according to the environment state of each section, and calculating an environment-evaluation value of each section, thereby determining an environment-evaluation rank of the transmission line as a route based on environment-evaluation values of the respective sections; and a means for evaluating reliability of the transmission line as a route, based on the facility-evaluation rank, the environment-evaluation rank, and redundancy of the transmission line as a route.

According to the fourth aspect of the present invention, the state in which each section of the transmission line is installed is obtained from the database for facility evaluation, the facility-evaluation value of each section is calculated according to the state in which each section is installed, whereby the facility-evaluation rank of the transmission line as a route is determined; the environment state in which each section of the transmission line is present is obtained as data from the database for environment evaluation, the environment-evaluation value of each section is calculated according to the environment state of each section, whereby the environment-evaluation rank is determined; and reliability of the transmission line as a route is determined based on the facility-evaluation rank, the environment-evaluation rank, and redundancy of the transmission line as a route. Thus, reliability of the transmission line as a route is determined in an accurate and quantitative manner, so that the obtained data of reliability of the transmission line can be reflected on the facility-maintenance plan and the network-establishing plan in future. Further, as the critical points at the route are correctly grasped, checks for preventive maintenance and strategy-planning at the time of accidents can be conducted accurately and quickly, whereby reliability of the transmission line as a route is ensured.

In yet another preferred embodiment of the present invention, in the database for facility evaluation, for registering therein for management a state in which the transmission line is installed, the state in which the transmission line is installed includes: whether the transmission line is buried underground or not; and whether the transmission line is aerially provided or not, the state also including a depth at which the transmission line is buried if the transmission line is buried underground.

According to this embodiment, the evaluation of facilities of each section is carried out in consideration of the state in which each section of the transmission line is installed, which state including whether the transmission line is buried underground or not; and whether the transmission line is aerially provided or not, the state also including a depth at which the transmission line is buried if the transmission line is buried underground. Thus, the evaluation of facilities of the transmission line as a route can be accurately carried out.

In yet another preferred embodiment of the present invention, in the database for environment evaluation, for registering therein for management the environment state of the transmission line, the environment state of the transmission line includes at least one of: a location of a road under which road the transmission line lies; a state of soil; presence/absence of fire-proof protection; presence/absence of shallow underground section protection; and a state of urbanization.

According to this embodiment, the environment of the transmission line as a route is evaluated based on the environment state of each section, the environment state of each section including at least one of: a location of a road under which road the transmission line lies; a state of soil; presence/absence of fire-proof protection, presence/absence of shallow underground section protection; and a state of urbanization. Thus, evaluation of the environment of the transmission line as a route can be accurately carried out.

In order to achieve the aforementioned object, in a fifth aspect of the present invention, there is provided a program for evaluating reliability of a transmission line as a route constituted of a plurality of sections, the program executing the steps of: evaluating facilities of each of the sections constituting the transmission line as a route, according to a state in which each section is installed, and determining a facility-evaluation rank of the transmission line as a route based on an evaluation result of facilities; evaluating environment of each of the sections constituting the transmission line, according to a state of environment in which each section is present, and determining an environment-evaluation rank of the transmission line as a route based on an evaluation result of environment; and evaluating reliability of the transmission line as a route, based on the facility-evaluation rank, the environment-evaluation rank, and redundancy of the transmission line as a route.

According to the fifth aspect of the present invention, facilities of each of the sections of the transmission line are evaluated according to a state in which each section is installed and the facility-evaluation rank of the transmission line as a route is determined based on the evaluation result of facilities; the environment of each of the sections is evaluated according to a state of environment in which each section is present and the environment-evaluation rank of the transmission line as a route is determined based on the evaluation result of environment; and reliability of the transmission line as a route is evaluated based on the facility-evaluation rank, the environment-evaluation rank, and redundancy of the transmission line as a route. Thus, reliability of the transmission line as a route is determined in an accurate and quantitative manner, so that the obtained data of reliability of the transmission line can be reflected on the facility-maintenance plan and the network-establishing plan in future. Further, as the critical points at the route are correctly grasped, checks for preventive maintenance and strategy-planning at the time of accidents can be conducted accurately and quickly, whereby reliability of the transmission line as a route is ensured.

In order to achieve the aforementioned object, in a sixth aspect of the present invention, there is provided a recording medium in which a program has been recorded, the program being for evaluating reliability of a transmission line as a route constituted of a plurality of sections, the program executing the steps of: evaluating facilities of each of the sections constituting the transmission line as a route, according to a state in which each section is installed, and determining a facility-evaluation rank of the transmission line as a route based on an evaluation result of facilities; evaluating the environment of each of the sections constituting the transmission line, according to a state of environment in which each section is present, and determining an environment-evaluation rank of the transmission line as a route based on an evaluation result of environment; and evaluating reliability of the transmission line as a route, based on the facility-evaluation rank, the environment-evaluation rank, and redundancy of the transmission line as a route.

According to the sixth aspect of the present invention, a program for evaluating reliability of a transmission line as a route has been recorded in a recording medium, and by executing the program, facilities of each of the sections of the transmission line are evaluated according to a state in which each section is installed and the facility-evaluation rank of the transmission line as a route is determined based on the evaluation result of facilities; the environment of each of the sections is evaluated according to a state of environment in which each section is present and the environment-evaluation rank of the transmission line as a route is determined based on the evaluation result of environment; and reliability of the transmission line as a route is evaluated based on the facility-evaluation rank, the environment-evaluation rank, and redundancy of the transmission line as a route. In short, assignability of the present invention can be significantly enhanced by using the recording medium as described above.

The nature, principle and utility of the invention will become more apparent from the following detailed description when read in conjunction with the accompanying drawing.

### BRIEF DESCRIPTION OF THE DRAWINGS

In the accompanying drawings:

FIG. 1 is a block diagram showing the structure of a system for evaluating reliability of a transmission line as a route, which system implements a method of evaluating reliability of a transmission line as a route according to one embodiment of the present invention;

FIG. 2 is a table showing correspondence of the soil-covering rate to the facility-evaluation value;

FIG. 3 is a table showing environment-evaluation items for deciding environment-evaluation values;

FIG. 4 is a table showing correspondence of the number of the items satisfying the condition of a section, of the environment-evaluation items of FIG. 3, to the environment-evaluation value;

FIG. 5 is a table showing correspondence of the rate at which the environment-evaluation items of FIG. 3 satisfy the condition of a section, to the environment-evaluation rank; and

FIG. 6 is a table showing a matrix for evaluating reliability of a transmission line as a route.

### DESCRIPTION OF THE PREFERRED EMBODIMENTS

The embodiments of the present invention will be described hereinafter with reference to the drawings.

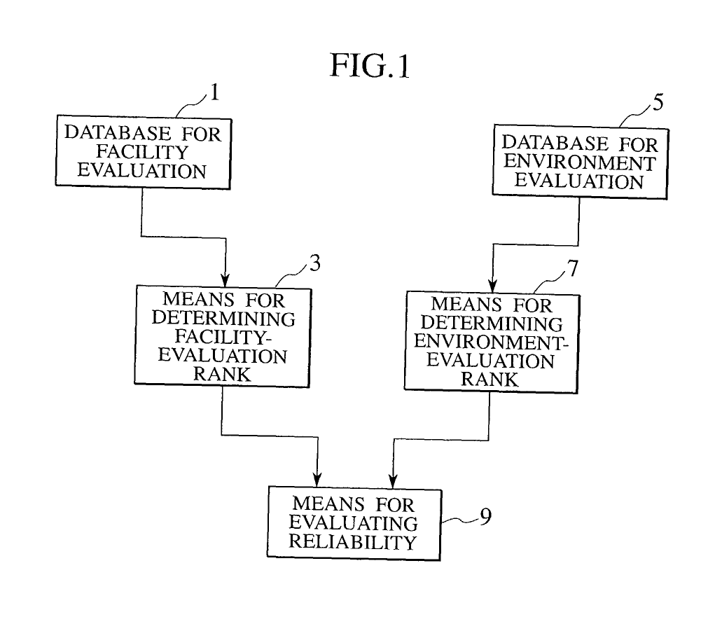

FIG. 1 is a block diagram showing the structure of a system for evaluating reliability of a transmission line as a route, which system implements a method of evaluating reliability of a transmission line as a route according to one embodiment of the present invention.

The system for evaluating reliability of a transmission line as a route, shown in FIG. 1, is a system for evaluating reliability of a transmission line as a route constituted of a plurality of sections. The system includes a database for facility evaluation 1, a means for determining facility-evaluation rank 3, a database for environment evaluation 5, a means for determining environment-evaluation rank 7, and a means for evaluating reliability 9.

The database for facility evaluation 1 registers, for management as data for each section of the transmission line as a route, the structure of each of the sections constituting the transmission line (the transmission line includes a transmission wire and a conduit for communication which accommodates the transmission wire) and a state in which each section is installed. The means for determining facility-evaluation rank 3 obtains, as data, the state in which each of the sections constituting the transmission line as a route is installed, from the database for facility evaluation 1. The means for determining facility-evaluation rank 3 then evaluates facilities of each section according to the state in which each section is installed, and calculates the facility-evaluation value of each section, thereby determining the facility-evaluation rank of the transmission line as a route based on the facility-evaluation values of the respective sections. The database for environment evaluation 5 registers therein, for management as data for each section of the transmission line as a route, an environment state in which each of the sections of the transmission line is present. The means for determining environment-evaluation rank 7 obtains as data the environment state of each of the sections constituting the transmission line as a route, from the database for environment evaluation 5. The means for determining environment-evaluation rank 7 then evaluates environment of each section according to the environment state of each section, and calculates the environment-evaluation value of each section, thereby determining the environment-evaluation rank of the transmission line as a route based on the environment-evaluation values of the respective sections. The means for evaluating reliability 9 evaluates reliability of the transmission line as a route, based on the facility-evaluation rank determined by the means for determining facility-evaluation rank 3, the environment-evaluation rank determined by the means for determining environment-evaluation rank 7, and the redundancy or the line relief rate obtained in consideration of the redundancy, of the transmission line as a route.

Here, the term “section” represents, for example, a section between one manhole (MH) and another MH of a conduit for communication which accommodates a transmission line or a section between one transmission-line pole and another transmission-line pole on which power-transmission line is supported. For each section between manholes and transmission-line poles as described above, the structure of the transmission line at the section and the state in which the section is installed, for facility evaluation, as well as the environment state for environment evaluation of the section are set and registered for management in the database for facility evaluation 1 and the database for environment evaluation 5.

With regards to the data of the transmission line registered for management in the database for facility evaluation 1, the state in which the transmission line is installed includes: whether the transmission line is buried underground or not; and whether the transmission line is aerially provided or not, wherein, when the transmission line is buried underground, the depth at which the transmission line is buried is also evaluated.

With regards to the data of the transmission line registered for management in the database for environment evaluation 5, the environment state in which the transmission line is present includes: the location of the road (or the type of area occupied by the road) under which road the transmission line lies (specifically, whether the road is a driveway or in the vicinity of a cliff); the state of soil (specifically, the soil at the site where the conduit is buried is soft or the filled/mounded one; presence/absence of fire-proof protection in a section in which a bridge has been added; presence/absence of a protection for a conduit buried at a shallow underground section; the state of urbanization; presence/absence of an indication of conduit location on the road; presence/absence of information on the possibility of moving within 1 or 5 years; the rate of availability of facility recording drawings being 0% or 50%; and the rate of carrying out witness-observation being 0% or 50%.

The means for determining the facility-evaluation rank 3 evaluates facility of each of the sections constituting the transmission line as a route, based on the state in which each section is installed (the data of the state is registered for management in the database for facility evaluation 1). Specifically, the means for determining the facility-evaluation rank 3 evaluates facility of each of the sections constituting the transmission line as a route, based on the state in which each section is installed, the state including: whether the transmission line is buried underground or not; and whether the transmission line is aerially provided or not, wherein, when the transmission line is buried underground, the depth at which the transmission line is buried is also evaluated, as described above. The means for determining the facility-evaluation rank 3 then calculates the facility-evaluation value of each section of the transmission line. In the calculation of the facility-evaluation value, facility-evaluation values of “1” to “4” are each assigned to the corresponding facility evaluation results ranging from “excellent (highest possible evaluation)” to“poorest(lowest possible evaluation)”. Here, the facility-evaluation value “1” corresponds to the facility evaluation of “excellent” and the facility-evaluation value “4” corresponds to the facility evaluation of “poorest”.

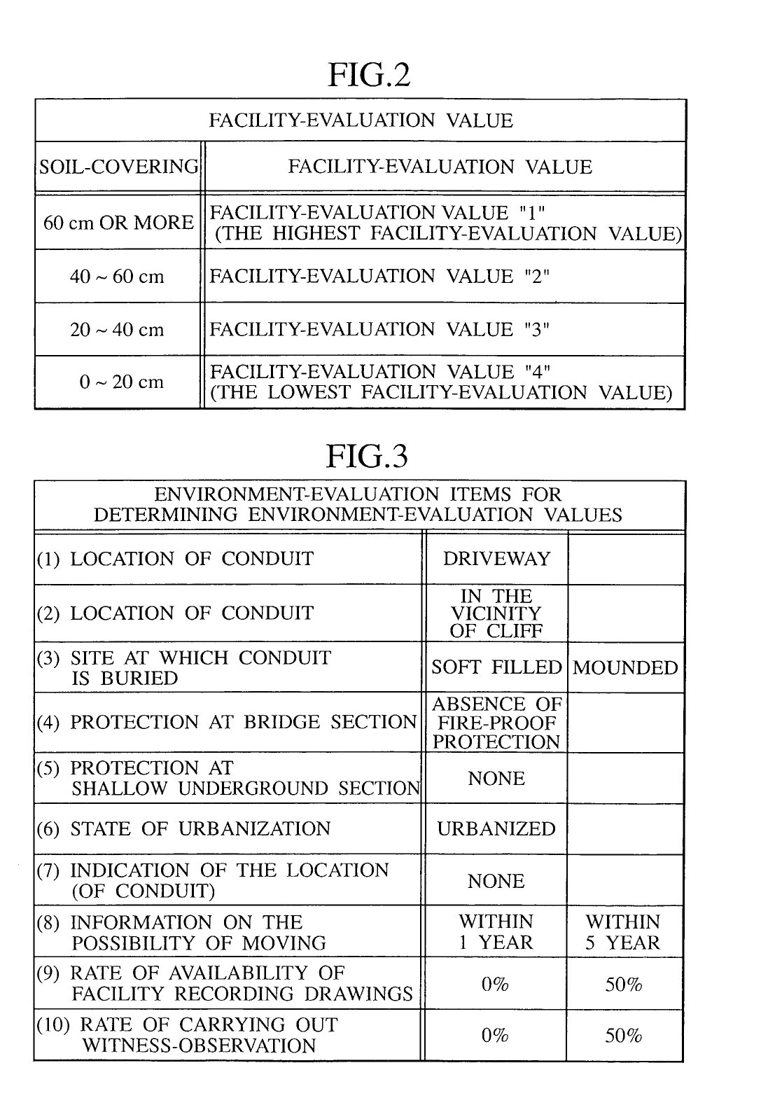

In a case in which the transmission line is an aerial cable, the poorest facility evaluation value of “4” is assigned thereto. In a case in which the transmission line is buried underground, the facility evaluation value thereof is defined according to the state of soil-covering at the site (i.e., the depth at which the section of line is buried), as shown in FIG. 2.

The means for determining the facility-evaluation rank 3 calculates the facility-evaluation value of each section of the transmission line as a route, based on (the data of) the state in which each section is installed, obtained from the database 1 for facility evaluation. The facility-evaluation values of the sections calculated as described above are summed up, and the facility-evaluation values of the intermediate-total sections (e.g., sections each defined between main buildings along the transmission line as a route) are calculated. The facility-evaluation value of each route is then calculated. Finally, the facility-evaluation rank of the transmission line as a route is determined. The facility-evaluation rank ranges, for example, from the facility-evaluation rank “1” as “excellent” to the facility-evaluation rank “4” as “poorest”.

The means for determining the environment-evaluation rank 7 evaluates environment of each of the sections constituting the transmission line as a route, based on the state of environment in which each section is present (the data thereof is registered for management in the database for environment evaluation 5). Specifically, the means for determining the environment-evaluation rank 7 evaluates environment of each of the sections constituting the transmission line as a route, based on the state of the environment in which each section is present, according to the ten items of evaluating environment, as shown in FIG. 3. The means for determining the environment-evaluation rank 7 then calculates the environment-evaluation value of each section of the transmission line. In the calculation of the environment-evaluation value, environment-evaluation values of “1” to “4” are each assigned to the corresponding environment evaluation results ranging from “excellent (highest possible evaluation) ” to “poorest (lowest possible evaluation)”. Here, the environment-evaluation value “1” corresponds to the environment evaluation of “excellent” and the environment-evaluation value “4” corresponds to the environment evaluation of “poorest”.

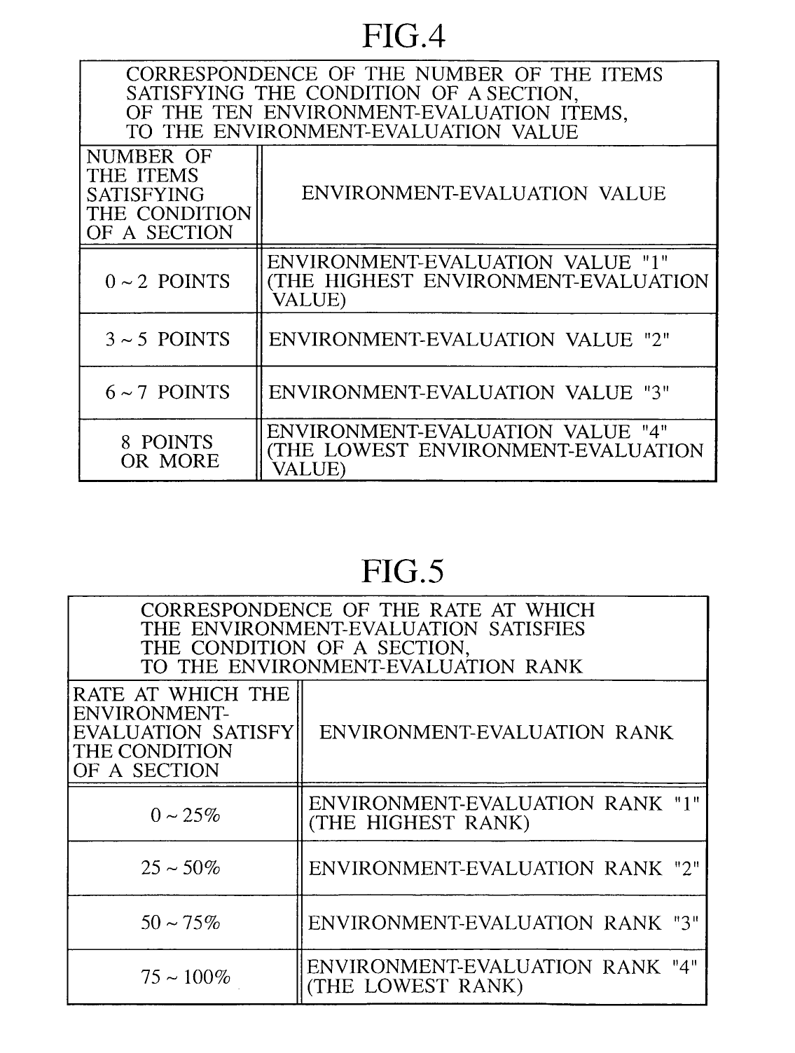

In order to calculate the environment-evaluation value of each section from the environment state thereof according to the items for evaluating environment shown in FIG. 3, the following method, can be employed. Specifically, the environment of each section is evaluated according to the number of the items which satisfy the condition of the section, of the ten items listed in FIG. 3. That is, the environment-evaluation values are obtained as the environment-evaluation values of “1” to “4” described above, according to the number of the items which satisfy the condition of the section, of the ten items listed in FIG. 3. The correspondence of the number of the items satisfying the condition of the section, to the environment-evaluation value, is shown in FIG. 4.

Specifically, if the environment state of one section of a transmission line as a route satisfies three of the ten items for evaluating environment shown in FIG. 3. Namely, for example, if the environment state of one section of a transmission line as a route satisfies the item (1) “driveway”, (2) “in the vicinity of a cliff” and (3) the soil being “soft”, of the ten items for evaluating environment of FIG. 3, these three items are regarded as the environment-evaluation items to be monitored with caution. That is, when three of the ten items for evaluating environment satisfy the condition of the section (i.e., 3 points in FIG. 4), the environment-evaluation value “2” is obtained as the environment-evaluation value which corresponds to “3 points” of FIG. 4. In a case in which the transmission line is an aerial transmission line, it is assumed that all the ten items for evaluating environment of FIG. 3 satisfy the condition of the transmission line. That is, as the number of the items for evaluating environment, to be monitored with caution, is ten (ten points in FIG. 4), the poorest environment-evaluating value “4” is assigned thereto.

The aforementioned correspondence of the number of the items for evaluating environment which satisfy the condition of one section of a transmission line, to the environment-evaluation value, can be similarly applied to an intermediate-total section such as that each defined between main buildings. Specifically, when one intermediate-total section is constituted of 20 sections in a transmission line, the number of the items for evaluating environment in the 20 sections are 200 (20×10). If 120 items, of the 200 items for evaluating environment of the same type as those of FIG. 3, satisfy the condition of the intermediate-total section, in other words, if the number of the items for evaluating environment, to be monitored with caution, in the intermediate-total section is 120, the rate at which the environment-evaluation items satisfy the condition of the intermediate-total section is 60% (120/200). The environment-evaluation rank is then determined with respect to the intermediate-total section, in a range from the environment-evaluation rank “1” to the environment-evaluation rank “4”, as shown in FIG. 5, according to the percentage of the rate at which the environment-evaluation items satisfy the condition of the intermediate-total section.

When the environment-evaluation rank is determined for each of the intermediate-total sections, as described above, then the environment-evaluation rank of the route unit can be similarly determined. When the environment-evaluation rank is determined by the unit of a route, FIG. 5 i.e., the correspondence of the rate at which the environment-evaluation items satisfy the condition of an intermediate-total section, to the environment-evaluation rank, can be used. In the present specification, calculation of the environment-evaluation value and determination of the environment-evaluation rank are described in detail, while calculation of the facility-evaluation value and determination of the facility-evaluation rank, for an intermediate-total section and a route, are briefly summarized in that “calculation/determination of the facility-evaluation value/rank, for an intermediate-total section and a route, is carried out by summing up the facility-evaluation values of the sections”. However, it should be noted that such calculation/determination of the facility-evaluation value/rank at the larger unit than a section, of a transmission line, are carried out in a manner similar to that in calculation/determination of the environment-evaluation value/rank.

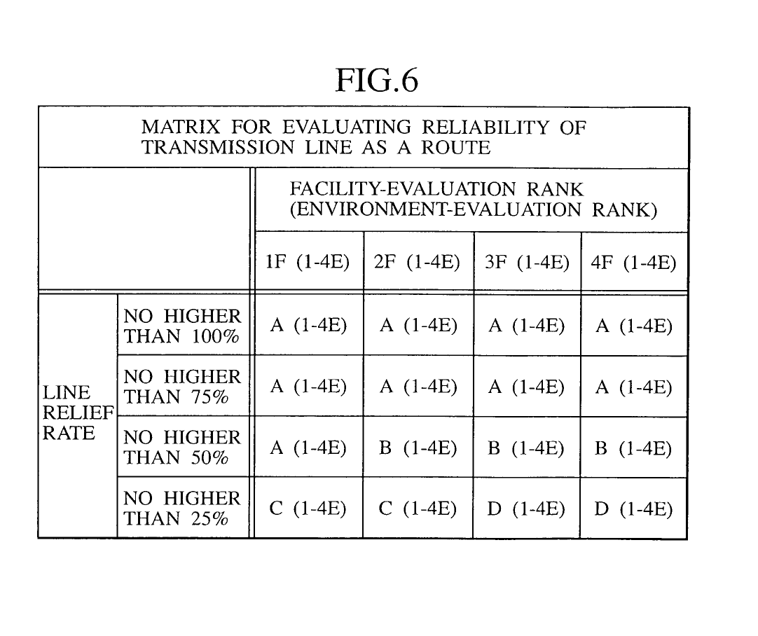

As described above, when the facility-evaluation rank and the environment-evaluation rank of a transmission line as a route have been determined, the means for evaluating reliability 9 evaluates reliability of the transmission line as a route, based on the facility-evaluation rank, the environment-evaluation rank, and the redundancy or the line relief rate obtained in consideration of the redundancy, of the transmission line as a route. Here, the line relief rate is classified into four categories: no higher than 100%; no higher than 75%; no higher than 50%; and no higher than 25%. Based on the correspondence of the line relief rate to the facility-evaluation rank (the environment-evaluation rank) shown in the reliability-evaluation matrix of FIG. 6, reliability of the transmission line as a route is obtained in a range from the reliability-evaluation rank “1F-A” (the highest rank as the reliability-evaluation rank) to the reliability-evaluation rank “4F-D” (the lowest rank as the reliability-evaluation rank). The environment-evaluation rank is added thereto as a rank within parenthesis.

In FIG. 6, “1F” to “4F” each represent the facility-evaluation ranks “1” to “4”. “1-4E” is the abbreviation of “1E-4E”, and 1E” to “4E” each represent the corresponding environment-evaluation ranks. “A” to “D” each represent the reliability ranks “1” to “4”.

For example, if the facility-evaluation rank is the rank “2” i.e., “2F” and the environment-evaluation rank is the rank “3” i.e., “3E” in a transmission line as a route, the reliability-evaluation rank of the transmission line is “B3E” from the matrix of FIG. 6, when the line relief rate is 50%.

According to the embodiments described above, reliability of the transmission line as a route is determined in an accurate and quantitative manner, so that the obtained data of reliability of the transmission line can be reflected on the facility-maintenance plan and the network-establishing plan in future. Further, as the critical points at the route are correctly grasped, checks for preventive maintenance and strategy-planning at the time of accidents can be conducted accurately and quickly, whereby reliability of the transmission line as a route is ensured.

As described above, in the present invention, facilities of each of the sections of the transmission line is evaluated according to a state in which each section of line is installed and the facility-evaluation rank of the transmission line as a route is determined based on the evaluation result of facilities; the environment of each of the sections is evaluated according to a state of environment in which each section is present and the environment-evaluation rank of the transmission line as a route is determined based on the evaluation result of environment; and reliability of the transmission line as a route is evaluated based on the facility-evaluation rank, the environment-evaluation rank, and redundancy of the transmission line as a route. Thus, reliability of the transmission line as a route is determined in an accurate and quantitative manner, so that the defects at the transmission line as a route can be grasped. That is, checks for preventing accidents can be carried out, whereby reliability of the transmission line as a route is ensured.

Further, according to the present invention, the state in which each section of the transmission line is installed is obtained as data from the database for facility evaluation, and the facility-evaluation value of each section is calculated according to the state in which each section is installed, whereby the facility-evaluation rank of the transmission line as a route is determined; the environment state in which each section of the transmission line is present is obtained as data from the database for environment evaluation, and the environment-evaluation value of each section is calculated according to the environment state of each section, thereby determining the environment-evaluation rank; and reliability of the transmission line as a route is determined based on the facility-evaluation rank, the environment-evaluation rank, and redundancy of the transmission line as a route. Thus, reliability of the transmission line as a route is determined in an accurate and quantitative manner, so that the obtained data of reliability of the transmission line can be reflected on the facility-maintenance plan and the network-establishing plan in future. Further, as the critical points at the route are correctly grasped, checks for preventive maintenance and strategy-planning at the time of accidents can be conducted accurately and quickly, whereby reliability of the transmission line as a route is ensured.

It should be understood that many modifications and adaptations of the invention will become apparent to those skilled in the art and it is intended to encompass such obvious modifications and changes in the scope of the claims appended hereto.

What is claimed is:

1. A method of evaluating reliability of a transmission line as a route constituted of a plurality of sections, comprising the steps of:
evaluating facilities of each of the sections constituting the transmission line as a route, according to a state in which each section of line is installed, and determining a facility-evaluation rank of the transmission line as a route based on an evaluation result of facilities;
evaluating environment of each of the sections constituting the transmission line, according to a state of environment in which each section is present, and determining an environment-evaluation rank of the transmission line as a route based on an evaluation result of environment; and
evaluating reliability of the transmission line as a route, based on the facility-evaluation rank, the environment-evaluation rank, and redundancy of the transmission line as a route.

2. A method of evaluating reliability of a transmission line as a route according to claim 1, wherein, at the step of determining the facility-evaluation rank, the state in which each section of the transmission line is installed specifically includes: whether the transmission line is buried underground or not; and whether the transmission line is aerially provided or not, the state also including a depth at which the transmission line in buried if the transmission line is buried underground.

3. A method of evaluating reliability of a transmission line as a route according to claim 1, wherein, at the step of determining the environment-evaluation rank, the environment state of each section of the transmission line specifically includes at least one of: a location of a road under which road the transmission line lies; a state of soil; presence/absence of fire-proof protection; presence/absence of shallow underground section protection; and a state of urbanization.

4. A method of evaluating reliability of a transmission line as a route constituted of a plurality of sections, comprising the steps of:
registering, for management as data for each section of the transmission line as a route, a state in which each of the sections of the transmission line is installed, in a database for facility evaluation;
obtaining as data the state in which each section of the transmission line is installed, from the database for facility evaluation, evaluating facilities of each section according to the state in which each section is installed, and calculating the facility-evaluation value of each section, thereby determining the facility-evaluation rank of the transmission line as a route based on facility-evaluation values of respective sections;
registering, for management as data for each section of the transmission line as a route, an environment state in which each section of the transmission line is present, in a database for environment evaluation;
obtaining as data the environment state of each section of the transmission line, from the database for environment evaluation, evaluating environment of each section according to the environment state of each section, and calculating the environment-evaluation value of each section, thereby determining the environment-evaluation rank of the transmission line as a route based on environment-evaluation values of the respective sections; and
evaluating reliability of the transmission line as a route, based on the facility-evaluation rank, the environment-evaluation rank, and redundancy of the transmission line as a route.

5. A method of evaluating reliability of a transmission line as a route according to claim 4, wherein, at the step of registering as data a state in which the transmission line is installed, for management in a database for facility evaluation, the state in which the transmission line is installed specifically includes: whether the transmission line is buried underground or not; and whether the transmission line is aerially provided or not, the state also including a depth at which the transmission line is buried if the transmission line is buried underground.

6. A method of evaluating reliability of a transmission line as a route according to claim 4, wherein, at the step of registering as data an environment state in which the transmission line is present, for management, in a database for environment evaluation, the environment state of each section of the transmission line specifically includes at least one of: a location of a road under which road the transmission line lies; a state of soil; presence/absence of fire-proof protection; presence/absence of shallow underground section protection; and a state of urbanization.

7. A system for evaluating reliability of a transmission line as a route constituted of a plurality of sections, comprising:
a means for evaluating facilities of each of the sections constituting the transmission line as a route, according to a state in which each section of line is installed, and determining a facility-evaluation rank of the transmission line as a route based on an evaluation result of facilities;
a means for evaluating environment of each of the sections constituting the transmission line, according to a state of environment in which each section is present, and determining an environment-evaluation rank of the transmission line as a route based on an evaluation result of environment; and
a means for evaluating reliability of the transmission line as a route, based on the facility-evaluation rank, the environment-evaluation rank, and redundancy of the transmission line as a route.

8. A system for evaluating reliability of a transmission line as a route according to claim 7, wherein, in the means for evaluating facilities of each section and determining the facility-evaluation rank, the state in which each section of the transmission line is installed specifically includes: whether the transmission line is buried underground or not; and whether the transmission line is aerially provided or not, the state also including a depth at which the transmission line is buried if the transmission line is buried underground.

9. A system for evaluating reliability of a transmission line as a route according to claim 7, wherein, in the means for evaluating environment of each section and determining the environment-evaluation rank, the environment state of each section of the transmission line specifically includes at least one of: a location of a road under which road the transmission line lies; a state of soil; presence/absence of fire-proof protection; presence/absence of shallow underground section protection; and a state of urbanization.

10. A system for evaluating reliability of a transmission line as a route constituted of a plurality of sections, comprising:
a database for facility evaluation for registering therein, for management as data for each section of the transmission line as a route, a state in which each of the sections of the transmission line is installed;
a facility-evaluation rank determining means, for obtaining as data the state in which each section of the transmission line is installed, from the database for facility evaluation, evaluating facilities of each section according to the state in which each section is installed, and calculating a facility-evaluation value of each section, thereby determining a facility-evaluation rank of the transmission line as a route based on facility-evaluation values of respective sections;
a database for environment evaluation for registering therein, for management as data for each section of the transmission line as a route, an environment state in which each section of the transmission line is present;
an environment-evaluation rank determining means, for obtaining as data the environment state of each section of the transmission line, from the database for environment evaluation, evaluating environment of each section according to the environment state of each section, and calculating an environment-evaluation value of each section, thereby determining an environment-evaluation rank of the transmission line as a route based on environment-evaluation values of the respective sections; and
a means for evaluating reliability of the transmission line as a route, based on the facility-evaluation rank, the environment-evaluation rank, and redundancy of the transmission line as a route.

11. A system for evaluating reliability of a transmission line as a route according to claim 10, wherein, in the database for facility evaluation, for registering therein, for management, a state in which each section of the transmission line is installed, the state in which the transmission line is installed specifically includes: whether the transmission line is buried underground or not; and whether the transmission line is aerially provided or not, the state also including a depth at which the transmission line is buried if the transmission line is buried underground.

12. A system for evaluating reliability of a transmission line as a route according to claim 10, wherein, in the database for environment evaluation, for registering therein, for management, the environment state in which each section of the transmission line is present, the environment state of each section of the transmission line specifically includes at least one of: a location of a road under which road the transmission line lies; a state of soil; presence/absence of fire-proof protection; presence/absence of shallow underground section protection; and a state of urbanization.

13. A program for evaluating reliability of a transmission line as a route constituted of a plurality of sections, the program executing the steps of:
evaluating facilities of each of the sections constituting the transmission line as a route, according to a state in which each section of line is installed, and determining a facility-evaluation rank of the transmission line as a route based on an evaluation result of facilities;
evaluating environment of each of the sections constituting the transmission line, according to a state of environment in which each section is present, and determining an environment-evaluation rank of the transmission line as a route based on an evaluation result of environment; and
evaluating reliability of the transmission line as a route, based on the facility-evaluation rank, the environment-evaluation rank, and redundancy of the transmission line as a route.

14. A recording medium in which a program has been recorded, the program being for evaluating reliability of a transmission line as a route constituted of a plurality of sections, the program executing the steps of:
evaluating facilities of each of the sections constituting the transmission line as a route, according to a state in which each section of line is installed, and determining a facility-evaluation rank of the transmission line as a route based on an evaluation result of facilities;
evaluating environment of each of the sections constituting the transmission line, according to a state of environment in which each section is present, and determining an environment-evaluation rank of the transmission line as a route based on an evaluation result of environment; and
evaluating reliability of the transmission line as a route, based on the facility-evaluation rank, the environment-evaluation rank, and redundancy of the transmission line as a route.
